(19) United States
(12) Patent Application Publication
(10) Pub. No.: US 2006/0234157 A1
(43) Pub. Date: Oct. 19, 2006

(54) Composition and method for printing a patterned resist layer

(75) Inventors: Anna Louise Bouwkamp-Wijnoltz, Eindhoven (NL); Arie Rombertus Van Doorn, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/552,946

(22) PCT Filed: Apr. 13, 2004
(86) PCT No.: PCT/IB04/50423

§ 371 Date: Oct. 13, 2005

(30) Foreign Application Priority Data
Apr. 16, 2003 (EP) 03101028.3

(51) Int. Cl. G03C 1/00

(52) U.S. Cl. 430/270.1

(57) ABSTRACT

The invention relates to a composition for printing a patterned resist layer onto an underlying, preferably etchable layer comprising: a) an acid-functional resin that is soluble in alkaline medium and insoluble in acidic medium, having an acid number of at least 100 mg KOH/g; b) a base solvent having a boiling point between 100 and 250° C.; and c) a tackifying solvent having a boiling point between 200 and 350° C.; provided that the boiling point of the tackifying solvent is higher than the boiling point of the base solvent. The invention further relates to a method for making a patterned layer, a pixel design, and an LCD display.

The invention relates to a composition for printing a patterned resist layer onto an underlying, preferably etchable layer and to a method for making a patterned resist layer. The invention further pertains to making a pixel design and a liquid crystal display (LCD) using said method.

Patterned resist layers are commonly used in the LCD industry. All commercially available resist layers are photoresist layers, since these layers should be photo patternable. These resist layers are usually applied onto an etchable layer by spin-coating of a low viscosity solvent with fast evaporating solvents or as a solvent-free system in the case of a negative resist. Thus this method requires at least three process steps, i.e. a spin-coating step and a photolithographic step for making a pattern in the spin-coated layer, and a development step of the photoresist. Particularly, the photolithographic step adds to the costs of making LCD displays, because this step requires photomask exposure, development, and usually drying and baking of the patterned layer. Therefore there is a need for reducing costs, especially when large substrates have to be provided with a resist layer. Further, use of LCD displays in low-tech products also requires cheaper LCD displays.

It is an objective of the invention to provide a method for making resist layers and LCD displays without using a photolithography process. It is a further objective to provide simple and cheap compositions to perform said methods. The inventors have now found that the photolithographic step can be deleted by a method of directly bringing a patterned resist layer onto the etchable layer, applying printing techniques. This is of particular interest when making LCD television displays wherein the pixels have larger dimensions, allowing the use of conventional printing techniques. It was also found that on using printing techniques for making resist layers no longer a need exists in using curable compositions and expensive cross-linkers, and milder cleaning agents can be used.

To this end the invention relates to a composition for printing a patterned resist layer onto an underlying, preferably etchable layer comprising:
a) an acid-functional resin that is soluble in alkaline medium and insoluble in acidic medium, having an acid value of at least 100 mg KOH/g;
b) a base solvent having a boiling point between 100 and 250° C.; and
c) a tackifying solvent having a boiling point between 200 and 350° C.; provided that the boiling point of the tackifying solvent is higher than the boiling point of the base solvent.

Resin-containing compositions for use as printing ink are known in the art. For instance, Japanese patent application JP 16219169 discloses ink suitable for intaglio printing. This composition contains a polyester resin cross-linked with a melamine resin and a glycol derivative or cyclic ether derivative with protected hydroxy groups with a boiling point 100-250° C. as solvent. Such composition can be provided with a pigment and be directly printed to color filters. Such composition, however, is not suitable for making an etch-resistant layer (resist layer). Further, as was disclosed in Japanese patent application JP 10088055, to provide sufficient releasabilty from a form plate, the composition should contain silicone oil in addition to the binder and pigment. None of these prior art compositions are non-curable or can be used for replacing the photolithographic process of making an etch-resistant layer.

The acid-functional resin may be any resin that can withstand the etching procedure under acidic conditions, usually in aqueous acidic medium. The acid-resistant properties must last at least during a time sufficient to perform the etching procedure, which usually is 1 to 10 minutes. Further, the resin should be soluble in the solvent system that is required to perform the invention. On the other hand, the resin should be sufficiently soluble in alkaline medium such as alkaline aqueous medium, to allow removal of the resin after the etching process within economically reasonable time. It is further a prerequisite that the resin has an acid number of at least 100 mg KOH/g, preferably at least 150 mg KOH/g, and most preferably at least 200 g KOH/g. For applications in (polysilicon) semiconductors the resin preferably comprises less than 5 ppm of sodium, potassium and/or halogen, more preferably less than 2 ppm. It is not required that the resin is cross-linkable, but cross-linkable resins can equally well be used. Thus any acid-containing polymers such as acrylic, methacrylic, polyester, polyamide, polyurethane, and the like can be used. Preferably, the resins are water-soluble. The acid groups are usually COOH groups, but sulfonic acid-containing and phosphonic acid-containing resins may also be used. Preferred resins are acrylic resins, for instance acrylic resins that are obtainable under the trade name Joncryl® (ex Johnson Polymer). In many instances it is an advantage to use the resin as a dry material, which allows a more easy preparation of the printing composition. The resin may have a wide variety of mol weights. Usually the weight average mol weight (M_{w}) is between 250 and 20,000. In case that acrylic resin is used, preferred mol weights are between 1,000 and 10,000, most preferably between 1,500 and 2,500. The resin may be one of the hereinbefore-mentioned resins or a mixture of such resins.

Preferably, a dye is added to the resin. The function of the dye is to enable the visual inspection of the pattern during printing, etching, and removal of the resist. The dye has no other functional effect during the process. No other requirements apply for the dyes than that they are compatible with the process, i.e. that they are acid-resistant and dissolve in alkaline medium, and that they do not disturb the printing process. Non-limitative examples of suitable dyes are Orasol Blue BL (C.I. Solvent Blue 136) (ex Ciba), Savinyl Blue RS (C.I. Solvent Blue 45) (ex Clariant), and Zapon Red 355 (ex BASF).

The base solvent should be a solvent in which the acid-functional resin sufficiently dissolves, and which allows transfer of ink during the printing process. For instance, when using gravure offset printing the base solvent should have affinity to the rubber blanket, which usually is of the silicone rubber type, to allow adhesion thereto. The base solvent should also be evaporable after the transfer from the blanket to the printing surface. The adhesion and evaporation properties require a balance of boiling point, which is between 100 and 250° C. Suitable solvents are, for instance, glycol esters and propylene glycol esters. Alkyl, aryl, and aralkyl esters are preferred, and preferably no free hydroxy groups are present. Alkyl (C₁-C₆) glycol esters, such as butyl glycol acetate, are very convenient base solvents, particularly in combination with acrylic resins. The base solvent may also be a mixture of solvents.

In gravure offset printing, due to evaporation of the base solvent and/or absorption into the silicone blanket, the ink on the blanket starts to lose the solvent and the ink becomes dry, i.e. its internal cohesion increases and the adhesion to the blanket decreases. The (partially) dried ink must then be transferred to the underlying, preferably etchable layer. Such transfer only occurs when the ink tackifies to the underlying, preferably etchable layer. For obtaining sufficient tackifying power it is necessary to add to the base solvent a tackifying solvent. Such solvent should have a higher boiling point than the base solvent, to prevent its evaporation before the necessary evaporation of the base solvent. Suitable solvents include but are not restricted to high-boiling solvents such as tributyrin (glycerin tri-butyrate), ethyl carbitol acetate, butyl carbitol acetate, citrofol BI (tributyl citrate), citrofol BII (acetyl tributyl citrate), tetraethylene glycol, tripropylene glycol. Very good results were obtained with tributyrin. Tackyifying solvents have boiling points between 250 and 350° C. Mixtures of tackifying solvents can also be used. It should be stressed that conventional tackifiers are liquid polymers that are tacky. Such polymers only have a minor effect on the transfer of the ink, and are usually inferior to the hereinbefore-mentioned tackifying solvents.

To obtain an optimum balance between evaporation rate and tackifying properties, which is necessary to obtain an acceptable time window for performing the process and which prevents occurrence of haze (ink outside the pattern) the ratio base solvent:tackifying solvent is preferably 95:5 to 30:70 (w/w), more preferably 80:20 to 40:60 (w/w). Such mixtures also yield good viscosity properties, which affect the performance of the process.

The invention also relates to a method for making a patterned layer comprising the steps of
a) printing the hereinbefore-mentioned resin composition onto an underlying etchable layer to obtain the underlying etchable layer overlaid with a patterned resist layer;
b) treating the etchable layer overlaid with the patterned resist layer with an acidic solution to obtain a patterned layer overlaid with the patterned resist layer; and
c) stripping the resin from the patterned layer overlaid with the patterned resist layer, by dissolving the resin in an alkaline solvent to obtain the patterned layer.

The printing process can be any common printing process, such as pad printing, offset printing, flexo printing, screen printing, stencil printing, ink jet printing, gravure printing, letterpress printing, and dispensing and dispense jet techniques. The invention is particularly suitable for gravure offset printing or intaglio printing.

In gravure offset printing the patterning plate is a gravure plate or cliché wherein the pattern is etched in the plate. The ink of lower viscosity compared to conventional printing (i.e. lithographic printing) and waterless offset printing techniques, is doctored in the gravure. The ink is taken out of the gravure by a roller comprising a silicone rubber blanket and transported to the substrate. During this transport the ink starts to dry and starts to build internal cohesion. When the ink reaches the substrate, the internal cohesion has become sufficient for the ink to be transferred completely to the substrate. The effect is a large decrease in print defects that would have been the case if ink-splitting had occurred.

Generally, the transfer mechanism in gravure offset is a result of disappearing solvent and so applicable to solvent-containing inks. Other, more exotic transfer mechanisms exist (e.g. temperature differences with thermoplastic inks, UV-cure during transfer, electro-assisted methods). This leads to the second advantage of gravure offset over conventional offset in that the print principle is mainly determined by the solvent composition and much less by the resin. This enables a much larger formulation freedom compared to the other offset techniques. So, gravure offset has intrinsically a relatively small amount of print defects and a large variety of possible inks to be used, including functional inks.

The etching and stripping steps are conventional steps that are also used in the known photolithography method. Thus etching can be performed by the dry etching methods, such as plasma etching and reactive ion etching, as well as by wet etching methods in acidic water. Stripping of the resist layer is performed by the usual alkaline treatment of the resist layer. In the experimental part specific details of these processes are given to illustrate these known methods.

If this method is applied to layers for making displays, particularly LCD displays, one or more of these layers can be patterned by the above method. For instance, a method for making a pixel design having at least two layers selected from conductive, semi-conductive, and insulating layers, comprises patterning at least one of said layers by the above method. These layers are comprises in the active plate and can be metal conductive layers comprising metal gate lines, amorphous silicon or silicon hydride layers, semi-conductive ITO layers, insulating layer, continuous passivation layers containing holes, and the like. Commonly, these layers are brought onto a substrate. The substrate can be glass or a polymeric material, such as polycarbonate, polyester, polyimide, and the like.

The invention is further illustrated by the following non-limitative examples.

Printing Machines

Two gravure offset printers were used: a large area printer (‘Korrex’; ex Max Simmel) and a in-house built test machine that is suitable for gravure offset as well as for pad printing (‘Limms’). Two pad printing machines have also been used: a closed ink reservoir system (‘Hermetic 61’; ex Tampoprint) and an open ink reservoir system (‘Tampo-print 125’; ex Tampoprint).

The Hermetic 61 uses typical cycle-times of 0.3-3 sec. It uses a closed ink cup, a cliché with size of 70×140×10 mm, a typical pattern size of 40×40 mm and round pads (60 mm diameter) to print on flat and curved substrates. All prints on the Hermetic are done with a 6 ShA Q3 silicone rubber pad type 410 (available from Tampoprint). The slowest speed was used, sometimes with an additional waiting time between pick up and deposit on the substrate.

The Limms machine uses the same cliché and ink cup device as the Hermetic. The movement of the cliché is performed by a computer controlled linear axis. On a second linear axis an air pressure device is attached containing a roller. To this roller the silicone rubber blanket is attached (total diameter 50 mm). The roller is operated under a pressure. For the Limms experiments the substrates were 50×75 mm glass plates.

Etch Resistance

To determine the etch resistance of the materials prints were made on samples containing Al on glass and Mo3% Cr on glass. For etching the aluminum the fol lowing solution was used:

| | |
|---|---|
| 85% orthophosphoric acid | 400 ml |
| 100% glacial acetic acid | 25 ml |
| 65% nitric acid | 25 ml |
| de-ionized water | 50 ml |

For etching the Mo3% Cr the following solution was used:

| | |
|---|---|
| 85% orthophosphoric acid | 7 ml |
| 65% nitric acid | 2 ml |
| de-ionized water | 2 ml |

The aluminum was etched at 40° C. and Mo3% Cr at room temperature. Etching was performed until all the metal was disappeared (visual control) while gently moving the samples in the etching solution. After etching the samples were rinsed with water. The resist layer was removed using concentrated ammonia at room temperature. The removal was almost instantly in most cases (visual control). Sometimes it took slightly longer. Then the samples were rinsed with de-ionized water and dried at room temperature.

The resistance against dry etching was determined on samples containing a stack of 330 nm SiNₓ, 160 nm i a-Si—H (inert amorphous silicon hydride) and 40 nm n⁺ a-Si—H (doped amorphous silicon hydride), printed on the n⁺ aSi—H. A Versalok dry etcher was used, with a SF₆+HCl gas mixture including end-point detection. This generally known etching procedure etches the i and n⁺ a-Si—H layers, down to the SiNₓ layer. Photoresist and SiNₓ etch rates are both known to be low compared to a-Si—H with this procedure.

A standard organic stripper was used to remove the resist after etching (4 min, 65° C.).

Materials

Glass substrates were used, of normal display glass. On the Korrex the sample size was 200×200 mm, on the Limms 50×75 mm. Cleaning involved only wiping with acetone or with water and soap (a solution of Remcotan 2-30 (mesh degreaser concentrate 1:10)) followed by rinsing with demineralized water and drying. This yielded prints with higher graphic quality.

Weighing the desired amounts of resin, solvents, and dye in ajar, and placing the closed jar on a roller bench. Dissolution was complete after one night. A few, more concentrated solutions, took another night.

All resists contained a dye, which is generally added as 0.5 wt % based on the total weight of the other ingredients.

Measurements

The dry factor, the remaining dry volume coming from a certain wet volume of resist was calculated based on densities.

Viscosities were measured on the Carrimed CS1² rheometer with a cone-plate geometry. A 4 cm 2 deg. steel spindle was used. The viscosity was measured with a stepped ramp cycle from 0.1 to 1200 to 0.1 S-1 in 4 min at 23° C.

The resins were tested for their printability on the Hermetic using a solution of the resin in 1-methoxy-2-propyl acetate. The pad printability results are:

| | | wt. % | Viscosity at | |
|---|---|---|---|---|
| Resin | Mw | solution | 100 s⁻¹ | Printability |
| Joncryl 682 | 1800 | 60 | 5.5 | + |
| Joncryl 586 | 4600 | 60 | 5.8 | + |
| Joncryl 680 | 4900 | 50 | 2.6 | − |
| Joncryl 678 | 8500 | 50 | 18.6 | + |
| Joncryl 683 | 9200 | 50 | 6.7 | − |
| Joncryl ECO 684 | 2000 | 50 | 5.7 | + |
| Joncryl ECO 675 | 5700 | 50 | 6.9 | − |

Etching results for aluminum on glass for these samples are:

| | Acid | Etching | Rinsing | Removal |
|---|---|---|---|---|
| Resin | number | Al | H₂0 | Layer# |
| Joncryl 682 | 240 | + | + | + |
| Joncryl 586 | 108 | +/−* | +/−* | − |
| Joncryl 680 | 215 | + | +/− | + |
| Joncryl 678 | 215 | + | − | + |
| Joncryl 683 | 150 | − | − | + |
| Joncryl ECO 684 | 243 | + | + | + |
| Joncryl ECO 675 | 222 | + | + | + |

Etching results for Mo3% Cr on glass for these samples are:

| | Acid | Etching | Rinsing | Removal |
|---|---|---|---|---|
| Resin | number | Al | H₂0 | Layer# |
| Joncryl 682 | 240 | + | + | + |
| Joncryl 586 | 108 | +/−* | +/−* | − |
| Joncryl 680 | 215 | + | + | + |
| Joncryl 678 | 215 | + | +/− | + |
| Joncryl 683 | 150 | + | +/− | + |
| Joncryl ECO 684 | 243 | + | + | + |
| Joncryl ECO 675 | 222 | + | + | + |

+ layer remains intact
+/− layer partly disappeared
− layer largely disappeared
*only minor defects
# + complete removal,
− incomplete removal

Joncryl 682 and Joncryl ECO 684 were tested for use as resist for the ASI layer (amorphous silicon islands layer). This was done for samples printed from a 20 μm depth cliché. The resist contained a red dye (Zapon Red 355). Dry resist layer thickness was 3.0 μm. Etching results are shown in the table:

| | | % Loss in resist thickness |
|---|---|---|
| Resin | Etch time | after ASI dry etching |
| Joncryl ECO 684 | 2′31″ | 3 |
| Joncryl682 | 2′44″ | 5 |

1. A composition for printing a patterned resist layer onto an underlying, preferably etchable layer comprising:
a) an acid-functional resin that is soluble in alkaline medium and insoluble in acidic medium, having an acid number of at least 100 mg KOH/g;
b) a base solvent having a boiling point between 100 and 250° C.; and
c) a tackifying solvent having a boiling point between 200 and 350° C.; provided that the boiling point of the tackifying solvent is higher than the boiling point of the base solvent.

2. The composition of claim 1 wherein the resin is acid-functional acrylic resin.

3. The composition of claim 1 wherein the Mw of the resin is between 250 and 20,000.

4. The composition of claim 1 wherein the base solvent is selected from glycol ester, propyleneglycol ester, and mixtures thereof.

5. The composition of claim 4 wherein the base solvent is butyl glycol acetate.

6. The composition of claim 1 wherein the ratio base solvent : tackifying solvent is 95:5 to 30:70 (w/w), more preferably 80:20 to 40:60 (w/w).

7. The composition of claim 1 and comprising less than 5 ppm of sodium, potassium and/or halogen.

8. A method for making a patterned layer comprising the steps of
a) printing the resin composition of claim 1 onto an underlying etchable layer to obtain the underlying etchable layer overlaid with a patterned resist layer;
b) treating the underlying etchable layer overlaid with the patterned resist layer with an acidic solution or by a reactive ion etching method to obtain a patterned layer overlaid with the patterned resist layer; and
c) stripping the resin from the patterned layer overlaid with the patterned resist layer, by dissolving the resin in an alkaline solvent to obtain the patterned layer.

9. The method according to claim 8 by using in step a) a gravure offset printing technique.

10. A method for making a pixel design that comprises at least two layers selected from conductive, semi-conductive, and insulating layers, by patterning at least one of said layers by the method according to claim 8.

11. A method for making a liquid crystal display comprising a step of making the pixel design according to the method of claim 10.
